(19) United States
(12) Patent Application Publication
(10) Pub. No.: US 2020/0184574 A1
(43) Pub. Date: Jun. 11, 2020

(54) A SYSTEM FOR SOCIAL INTERACTION BY MEANS OF TELECOMMUNICATION SYSTEM

(71) Applicant: SPOTA PTY LTD, Melbourne, Victoria (AU)

(72) Inventors: Justin BORG, Melbourne, Victoria (AU); Matt KALANDOS, Melbourne, Victoria (AU)

(21) Appl. No.: 16/307,571

(22) PCT Filed: Jun. 5, 2017
(86) PCT No.: PCT/AU2017/050550

§ 371 Date: Dec. 6, 2018

(30) Foreign Application Priority Data
Jun. 7, 2016 (AU) 2016902212

(51) Int. Cl. G06Q 50/00; H04W 4/21; H04W 4/021; H04W 4/02; H04W 12/00; H04W 68/00

(52) U.S. Cl. CPC G06Q 50/01; H04W 4/21; H04W 4/021; H04W 68/005; H04W 12/00502; H04W 12/00503; H04W 4/023

(57) ABSTRACT

A system for social interaction by means of telecommunication system is provided by the use of a button to activate the GPS social media social interaction for a short time and short range and provide indirect communication only for those in the immediate time and space relative to the user until direct communication is authorised.

### FIELD OF THE INVENTION

The present invention relates to a system for social interaction by means of telecommunication system and in particular to a system for geographical social interaction by means of telecommunication system.

The invention has been developed primarily for use in/with system for social interaction by means of telecommunication system and will be described hereinafter with reference to this application. However, it will be appreciated that the invention is not limited to this particular field of use.

### BACKGROUND OF THE INVENTION

A system for social interaction by means of telecommunication system can be said to be known. However such known system generally follows the approach of users being members of a club and the phones being always connected and a set of questions and answers in order to arrive at a link and then determine if interested to meet. This process can take days and weeks. It is very much subject to the information on the databases and to preconceived ideas and possible overstatements in the discussions.

It can be seen that there are substantial problems including:
i) Lack of transparency in process
ii) Loose arrangement of filtering
iii) Lack of spontaneity
iv) Need for considered approaches
v) The need to always be on the system;
vi) The availability of others to be reviewing you regardless of your wishes;
vii) Concerns of online stalking
viii) Concerns of false information.

The present invention seeks to provide a system for social interaction by means of telecommunication system, which will overcome or substantially ameliorate at least one or more of the deficiencies of the prior art, or to at least provide an alternative including one or more of problems which have been identified including:

1. The limitation of positional accuracy within 100 m

2. The battery drain

3. The need to be operative in limited time

4. The need to limit operation in range of operation

5. The need to be operative both in time and location for immediacy

6. The need to be selective in operation.

It is to be understood that, if any prior art information is referred to herein, such reference does not constitute an admission that the information forms part of the common general knowledge in the art, in Australia or any other country.

### SUMMARY OF THE INVENTION

The invention in one form provides a system for computer-implemented social networking service by means of telecommunication comprising: a central computing device; and a computer-readable storage device connectable to the computing device and having instructions stored thereon. The system further comprises:
a) a membership database connectable to the central computing device and adapted for a first user to ask for first user membership data to be limited to other users according to requested limiting criteria;
b) a timer controller adapted for each user selectively limiting time of activation of the system relative to them; and
c) a geographical determinator adapted for selectively limiting geographical range of activation of the system in which each user is located relative to another user;

Each of the users has a mobile telecommunication device, connectable to or integral with the central computing device and/or the computer-readable storage device, allowing selective communication between users.

The system instructions are executed by the computing device, and cause the computing device to perform operations comprising:
a) determining a first user criteria requirements for a first user interaction with regard a possible second user, wherein a user criteria being met is based on the automatic review of the membership database for possible second users within the computer-implemented social networking service;
b) determining that the criteria requirements of the first user and the operating criteria of the computer-implemented social networking service are met;
c) identifying a plurality possible second users using the social networking service and their connection addresses;
   wherein the system determines which of the plurality possible second users also fulfil all of the criteria of the membership database, the selected limited time of interaction and the selected limited geographical range being met and are therefore are actual possible second users to enact the computer-implemented social networking service by the first user being enabled to use their telecommunication device to initiate communication with one or more of the actual possible second users by the aid of the system and without knowledge of the communication address of the actual possible second users.

According to an aspect of the present invention, a system for social interaction by means of telecommunication system is provided by a system for social interaction by means of telecommunication system having readily time activatable program and GPS or other geographical location range.

A timer controller can be used to immediately enable for a fixed predetermined limited time. The fixed predetermined limited time to immediately enable timer controller can be of the order 0 to 10 minutes. In another version, the fixed predetermined limited time to immediately enable timer controller is of the order 0 to 2 minutes.

The invention of a system for social interaction by means of telecommunication system provides the benefit of providing a tool that allows for enhancement of social interaction on a more casual and immediate basis. Therefore, the users can be in the mood, be in a location be in party mode and therefore be available for immediate casual and informal communication. Alternatively, the users can have disabled the timer controller so that they are NOT in the mood, in a social frame of mind, otherwise occupied or in an area or venue against their taste and NOT have to participate in the system for social interaction by means of telecommunication system at that time.

According to a second aspect of the present invention, a system for social interaction by means of telecommunication system is provided by the use of a button to activate the GPS social media social interaction for a short time.

The timer controller can further comprise the use of a button on the user's telecommunication device to activate the social media social interaction by use of the computer-implemented social networking service for.
a short time.
A fixed predetermined limited time to immediately enable timer controller of the order 0 to 10 minutes.
a fixed predetermined limited time to immediately enable timer controller of the order 0 to 2 minutes.
only while the button is activated by being physically activated manually by first user.

The invention of a system for social interaction by means of telecommunication system provides the benefit of being readily enabled. The activation of the button is the only requirement for a user to selectively take their involvement in the system for computer-implemented social networking service by means of telecommunication from a standby mode to an active mode able to be substantially immediately assessed to be a first user or an actual possible second user. Therefore, the user does not need to go through a detailed computer and sign into a situation but on the immediacy of time and location and, in person, seeing persons of interest can use the system for social interaction by means of telecommunication system to enable agreed communication between users.

According to a third aspect of the present invention, a system for social interaction by means of telecommunication system is provided by the activation of the instantaneous search at that activated time to advise persons in predefined area and The activation of response by activated persons in the predefined area that receive notification.

The enabling to use the telecommunication device of the first user to communicate with the telecommunication device of the one or more of the actual possible second users is by retaining connection addresses private of the first user and actual possible second users from the first user and actual possible second users. However, the telecommunication can automatically go through an intermediary connection or the central computing device so as to retain connection addresses private of the first user and actual possible second users from the first user and actual possible second users.

The activation of the instantaneous search at that activated time advises persons in predefined area or range of location and the activation of the activated time provides an ability for response by actual possible second users in the predefined area to receive notification.

A controlled immediacy social interaction system using telecommunication means including the steps of:
A user seeing people of interest in immediate surrounds;
User activating a communication means with plurality of criteria including: member of group, in predefined area, fulfilling criteria of user (e.g. looking for male or female of age of 18 to 25 or 25 to 30 years)
System sending offer of connection to actual possible second users being people fulfilling criteria and with their system being activated
A second user able to respond to system offer with system response
A favourable system response able to be communicated to user
Enabling an instigation of not direct communication between user and favourable actual second users by means of telecommunication devices.

A computer-implemented method using one or more processors on one or more telecommunication devices, the method comprising: determining a first interactor user criteria requirements for a first user with regard a possible second user, wherein a user criteria being met is based on the automatic review of a database of possible second users within the computer-implemented social networking service; determining that the criteria requirements of the first user and the operating criteria of the computer-implemented social networking service are met; identifying a plurality possible second users using the social networking service and their connection addresses; and in response to determining which of the plurality possible second users also meet fulfilling of all of the criteria of database, time and position being met and are therefore are actual possible second users to enact the computer-implemented social networking service by the first user being enabled to use their telecommunication device to communicate with one or more of the actual possible second users.

The method for use in controlled immediacy social interaction preferably using in combination:

i) A limited time range;

ii) A limited geographical range; and

iii) A limited criteria activation range.

The timer controller most preferably and with most benefits further comprises the use of a button on the user's telecommunication device to activate the social media social interaction by use of the computer-implemented social networking service for a short time.

The timer controller can able to immediately enable for a fixed predetermined limited time such as of the order 0 to 10 minutes or of the order 0 to 2 minutes.

The timer controller can further comprise the use of a button on the users' telecommunication device to activate the social media social interaction by use of the computer-implemented social networking service for a short time.

The short time can be the fixed predetermined limited time to immediately enable timer controller of the order 0 to 10 minutes or of the order 0 to 2 minutes.

However, in one form the short time can be only while the button is activated actively by the user. This immediacy can be such that the activation of the button is the only requirement for a user to selectively take their involvement of the system for computer-implemented social networking service by means of telecommunication from a standby mode to an active mode able to be substantially immediately assessed to be a first user or an actual possible second user.

In one form the invention provides a system for computer-implemented social networking service by means of telecommunication comprising: a central computing device; and a computer-readable storage device connectable to the computing device and having instructions stored thereon which, when executed by the computing device, cause the computing device to perform operations comprising: determining a first interactor user criteria requirements for a first user with regard a possible second user, wherein a user criteria being met is based on the automatic review of a database of possible second users within the computer-implemented social networking service; determining that the criteria requirements of the first user and the operating criteria of the computer-implemented social networking service are met; identifying a plurality possible second users using the social networking service and their connection addresses; and a mobile telecommunication device, for each user and connectable to or integral with the central computing device and/or the computer-readable storage device, allowing selective communication between users; the system further comprising: a membership database connectable to central computing device adapted for a first user to ask for other membership data of other users to be limited according to requested limiting criteria; a timer controller adapted for each user selectively limiting time of activation of the system relative to them; and a geographical determinator adapted for selectively limiting geographical range of activation of the system in which each user is located relative to another user; wherein the system determines which of the plurality possible second users also meet fulfilling of all of the criteria of database, time and position being met and are therefore are actual possible second users to enact the computer-implemented social networking service by the first user being enabled to use their telecommunication device to communicate with one or more of the actual possible second users; wherein the system for social interaction by means of telecommunication system can be substantially providing improvements including any one or more of the following:
i. improvements in structure and operation to minimise tortuous and demanding fixed operations;
ii. Improvements in effective immediacy of action;
iii. Improvements in system enabling informal and
iv. Improvements in portability of access to system;
v. Improvements in security;
vi. Improvements in efficiency and efficacy so as to not require full updates and searches of all possible users;
vii. Improvements in choice and timing of users using the system whether as a first user looking to initiate contact or as a possible second user wishing or not wishing to be on the considered contact list.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is diagrammatic illustration of a system for social interaction by means of telecommunication system in accordance with a preferred embodiment of the present invention showing fulfilling of all of the criteria of database, time and position;

FIG. 2 is diagrammatic illustration of a system for social interaction by means of use of a button on a telecommunication system to instigate immediacy and limited scope of fulfilling of all of the criteria of database, time and position;

FIG. 3 is diagrammatic view of an apparatus having a computer-readable storage device connectable to the computing device and having instructions stored thereon; and a mobile telecommunication device, for each user and connectable to or integral with the central computing device and/or the computer-readable storage device, allowing selective communication between users in a system for social interaction by means of telecommunication system in accordance with another preferred embodiment of the present invention;

FIG. 4. is a diagrammatic flow diagram of general actions in a computer-implemented method using one or more processors on one or more telecommunication devices for a system for social interaction by means of telecommunication system in accordance with a preferred embodiment of the present invention;

FIG. 5 is a tabular listing of range of criteria of the criteria of database, time and position used in system for social interaction by means of telecommunication system in accordance with a preferred embodiment of the present invention;

FIG. 6 is a diagrammatic flow diagram of a computer-implemented method using one or more processors on one or more telecommunication devices for a system for social interaction by means of telecommunication system in accordance with a preferred embodiment of the present invention;

FIG. 7 is a diagrammatic operation of indirect and direct communication between a first user and possible second user to maintain privacy and allow selective authorization by the second user of direct communication between first and second users;

FIGS. 8 to 10 and 11 to 12 are screen pages of a first and second embodiment respectively of an activation page of an app for use a system for social interaction by means of telecommunication system in accordance with a preferred embodiment of the present invention using fulfilling of all the criteria of database, time and position;

FIG. 13 is a screen page programmed as a touch screen virtual button for initiating determination of which of the plurality possible second users also fulfil all of the criteria of the membership database, the selected limited time of interaction and the selected limited geographical range being met and are therefore are actual possible second users;

FIG. 14 is diagrammatic block diagram views of operation by the button to the process of FIG. 13;

FIGS. 15 to 17 are screen pages showing connection details of first user and geographical indication of actual possible second user; and showing notification details of first user to actual possible second user;

FIGS. 18, 19 and 20 of actual possible second users dependent on predetermined criteria of geographical and time ranges; and

FIGS. 21 to 23 shows diagrammatic block diagram views of operation of the geographical limitation system for battery saving as achieved by adapting operation.

### DESCRIPTION OF PREFERRED EMBODIMENTS

It should be noted in the following description that like or the same reference numerals in different embodiments denote the same or similar features.

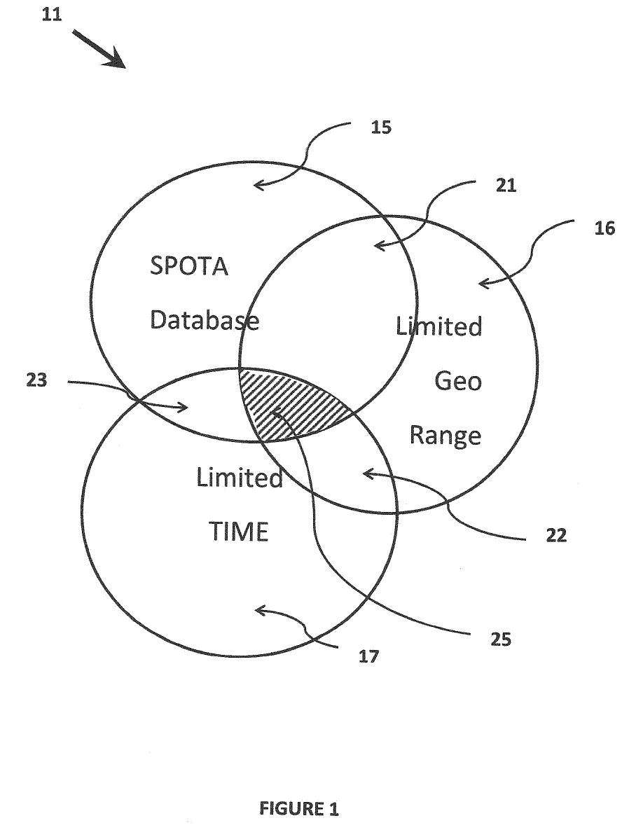

Referring to the drawings there is shown system for social interaction by means of telecommunication system. FIG. 1 is diagrammatic illustration of a system for social interaction by means of telecommunication system that uses the method of controlled immediacy social interaction preferably using in combination:

i) A limited time range;

ii) A limited geographical range; and

iii) A limited criteria activation range.

As shown in accordance with a preferred embodiment of the present invention there is the criteria of database as identified as SPOTA being numbered as 15, time as identified as TIME being numbered as 17 and position as identified as GPS being numbered as 16.

If time 17 and criteria of database 15 intersect as represented as 23 then you have to have a system of quickly determining if criteria are met. If position 16 and criteria of database 15 intersect as represented as 21 then you need to determine if persons within range have met criteria. If time 17 and position 16 intersect as represented as 22 then need to determine if any person within location at that time.

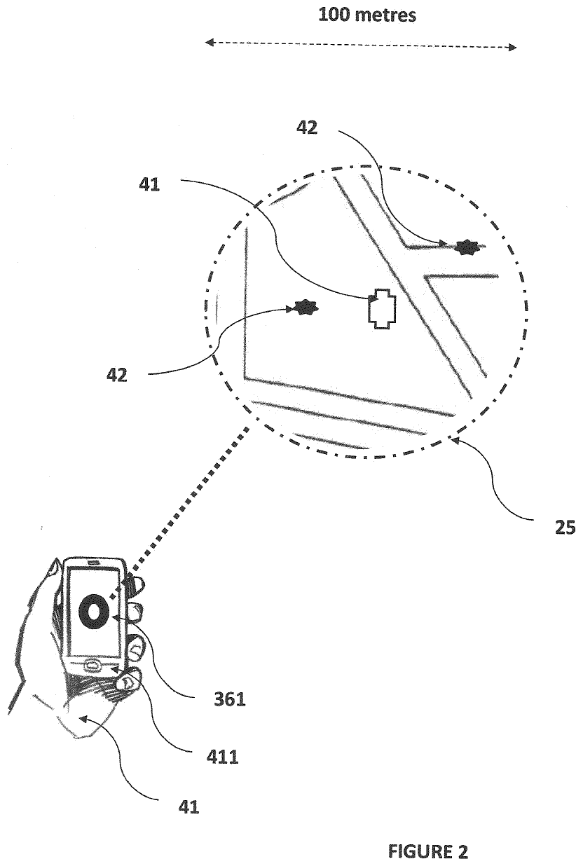

However, it is fulfilling of all the criteria of database, time and position as represented as 25 that provides the optimum advantage. By having to determine if persons meeting the criteria are within the limited geographical range at that time or within short window. Therefore, in this way the system is enabling quick and informal interactions at the present time. The mechanism for that timing is by a selective activation by the user. This is shown in FIG. 2.

The first user 41 has a telecommunication device 411 and on that device is a physical button or a screenshot providing a virtual button 361. As the person is going along the street, and presses the button 361, this enacts the immediate creation of a 100 metre range around the first user 41. The activation of the button activates the combination 25 of a limited time range; a limited geographical range; and a limited criteria activation range. This provides an immediacy of operation only when button is depressed and only for a short time period of minutes. The first user 41 in that immediacy identifies possible second users 42 in that immediacy and can selectively initiate indirect communication 421 to a second user 42.

A substantial advantage of this preferred embodiment is that a membership database is connectable to central computing device and is adapted for a first user to ask for other membership data of other users to be limited according to requested limiting criteria. A timer controller is adapted for each user selectively limiting the time of activation of the system relative to them. Further a geographical determinator adapted for selectively limiting geographical range of activation of the system in which each user is located relative to another user;

In this way, the system is not a slow review system in which all of the members are reviewed at all of the time and all of those are limited to see if they meet the criteria. Instead as shown by FIGS. 1 and 2, by fulfilling of all the criteria of database, time and position as represented as 25 that provides the effective advantage of the system only needing to deal with a limited number of prospective users as shown at 25.

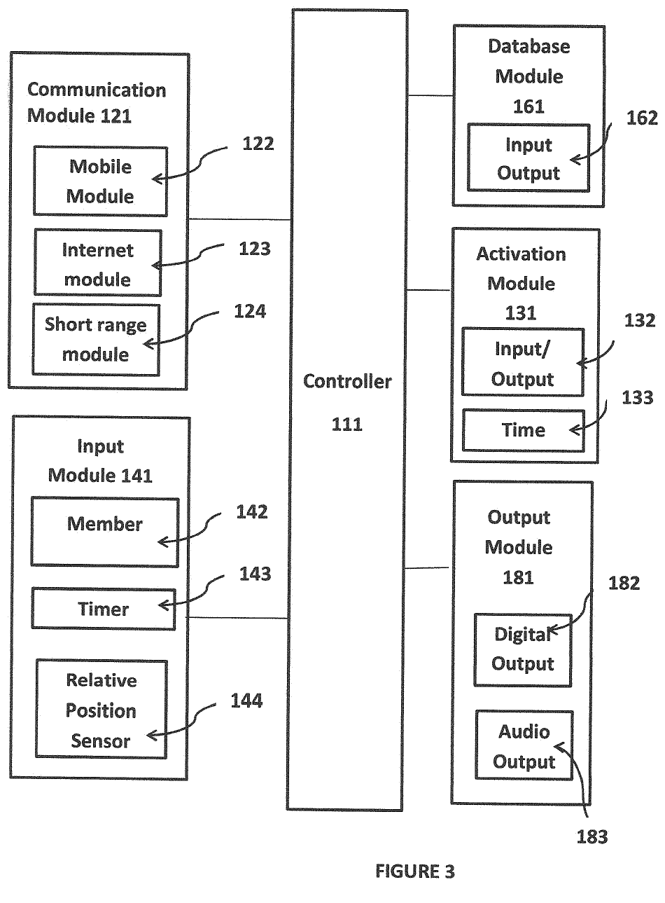

FIG. 3 is diagrammatic view of an apparatus having a computer-readable storage device connectable to the computing device and having instructions stored thereon; and a mobile telecommunication device, for each user and connectable to or integral with the central computing device and/or the computer-readable storage device, allowing selective communication between users in a system for social interaction by means of telecommunication system in accordance with another preferred embodiment of the present invention.

The apparatus has a controller 111, which links to a central computing device; and a computer-readable storage device and to the plurality of mobile telecommunication devices through one or more of the mobile module 122, or the internet module 123 or the short-range module 124 using Wi-Fi, Bluetooth etc.

By this communication module 121 there is facilitated the input from the input module 141 to the controller so that there is inputted the limited time range, limited geographical range, and limited criteria activation range.

A database module 161 which is fed data of members there is created a membership database connectable to central computing device is adapted for a first user to ask for other membership data of other users to be limited according to requested limiting criteria.

A timer controller is included in the activation module 131 and is adapted for each user selectively limiting time of activation of the system relative to them. The timer controller further comprises the use of a button on the user's telecommunication device to activate the social media social interaction for a short time. The short time is the fixed predetermined limited time to immediately enable timer controller. It can be set for an event or party so could be of the order 0 to 10 minutes. However, the primary aim is to be more spontaneous in communication so the short time is the fixed predetermined limited time to immediately enable timer controller of the order 0 to 2 minutes. However even more spontaneous is when the short time is only while the button is activated.

The geographical determinator can be a GPS sensor in the relative position sensor 144 of the input module and adapted for selectively limiting geographical range of activation of the system in which each user is located relative to another user.

The controller thereby uses a first interactor user criteria requirements for a first user with regard a possible second user, wherein a user criteria being met is based on the automatic review of a database of possible second users within the computer-implemented social networking service; determines that the criteria requirements of the first user and the operating criteria of the computer-implemented social networking service are met; and identifies a plurality possible second users using the social networking service and their connection addresses due to fulfilling of all of the criteria of database, time and position being met.

The communication module 121 can then allow the first user to be enabled to use their telecommunication device to communicate with one or more of the actual possible second users.

There also can be exclusion zones around the user by an electronic shield zone. In this way, a user's phone is undiscoverable or when a user is in a position that they do not want to be found it is excluded. Examples can be your home or work etc.

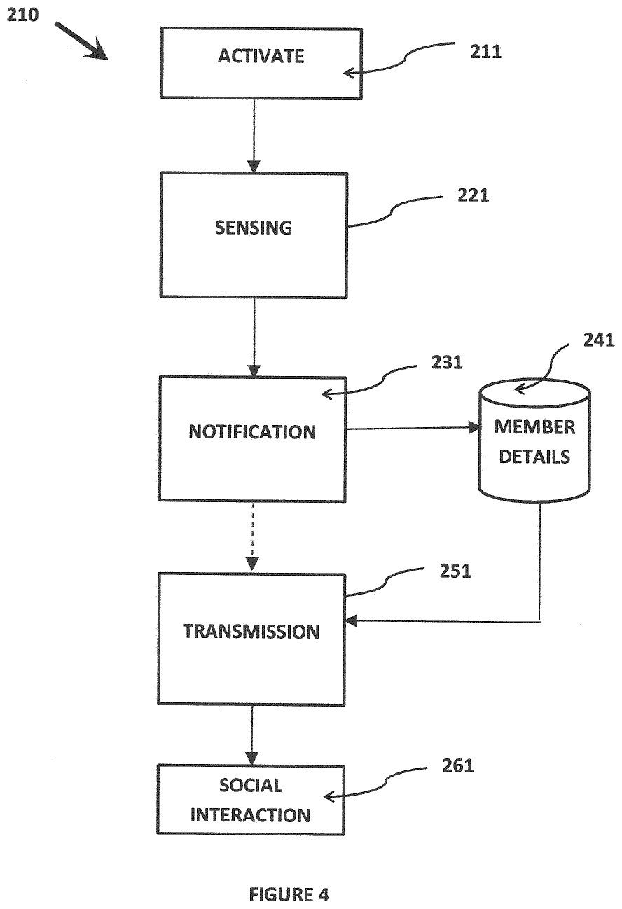

Referring to FIG. 4, the computer-implemented method uses one or more processors on one or more telecommunication devices determining a first interactor user criteria requirements for a first user with regard a possible second user. A user criteria being met is based on the automatic review of a database of possible second users within the computer-implemented social networking service.

The system 210 in general comprises the step 211 of activation by the first user and one or more second users. The assessment is made of which of the plurality of possible second users also meet fulfilling of all of the criteria of database, time and position being met and are therefore are actual possible second users to enact the computer-implemented social networking service by the first user. This leads to the first user undertaking step 231 of notification being sent to the possible second user and requiring access to member details in the database 241 while maintaining such details private. This enables step 251 of transmission by being enabled to use their telecommunication device to communicate with one or more of the actual possible second users. Therefore, the system has progressed through the steps of:
a) determining that the criteria requirements of the first user and the operating criteria of the computer-implemented social networking service are met;
b) identifying a plurality possible second users using the social networking service and their connection addresses; and
c) a mobile telecommunication device, for each user and connectable to or integral with the central computing device and/or the computer-readable storage device, allowing selective communication between users;

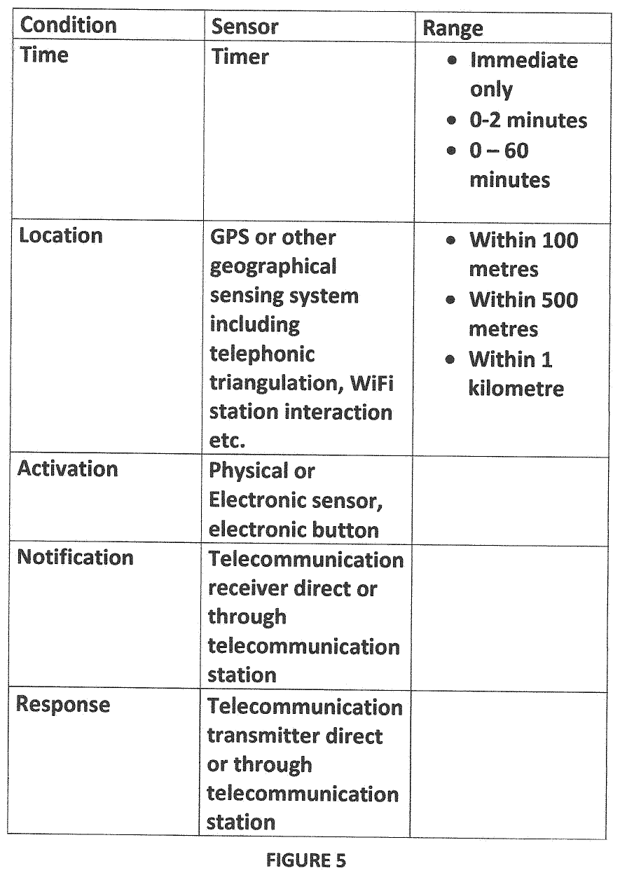

FIG. 5 is a tabular listing of range of criteria of the criteria of database, time and position used in system for social interaction by means of telecommunication system in accordance with a preferred embodiment of the present invention.

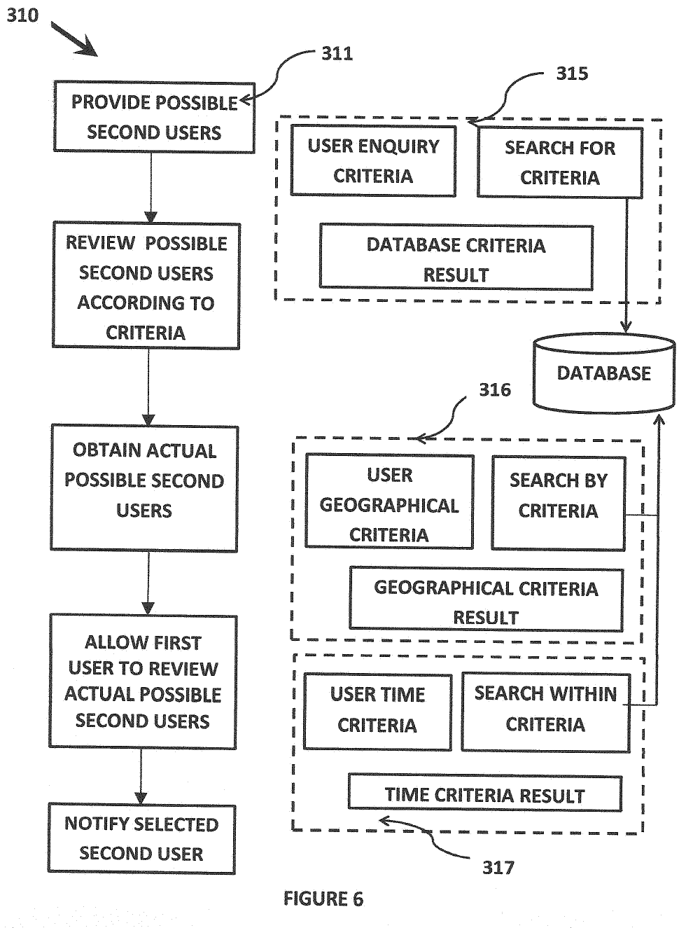

FIG. 6 is a diagrammatic flow diagram of a computer-implemented method using one or more processors on one or more telecommunication devices for a system for social interaction by means of telecommunication system in accordance with a preferred embodiment of the present invention. In undertaking that the plurality possible second users also meet fulfilling of all the criteria of database, time and position being met the assessment 311 uses three subroutines 315, 316, and 317 of review of:
i) a membership database connectable to central computing device adapted for a first user to ask for other membership data of other users to be limited according to requested limiting criteria;
ii) a geographical determinator adapted for selectively limiting geographical range of activation of the system in which each user is located relative to another user; and
iii) a timer controller adapted for each user selectively limiting time of activation of the system relative to them.

The system determines which of the plurality possible second users also meet fulfilling of all the criteria of database, time and position being met and are therefore are actual possible second users to enact the computer-implemented social networking service by the first user being enabled to use their telecommunication device to communicate with one or more of the actual possible second users.

Button

The button 361 is an innovative difference in that it is a physical button readily accessible on the user's telecommunication device 411. This button could be a large button that has a primary function but is programmable on the user's telecommunication device so as to be readily activated without the user looking at the device. In this way, it could be in the pocket of the user or merely secreted in the hand of the user and readily activated at a time the user wishes to start the immediacy social interaction using in combination:

i) A limited time range;

ii) A limited geographical range; and

iii) A limited criteria activation range.

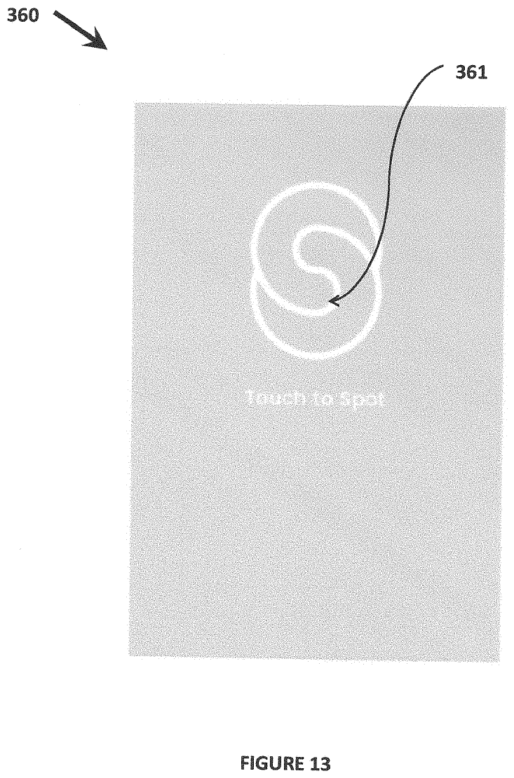

However preferably as shown in FIG. 13 the button can be a virtual button 361 which is programmable onto the screen of the mobile telecommunication device and is therefore readily activated by the user touching the large touchscreen and activating the search and determination of which of the plurality possible second users also fulfil all of the criteria of the membership database, the selected limited time of interaction and the selected limited geographical range being met and are therefore are actual possible second users.

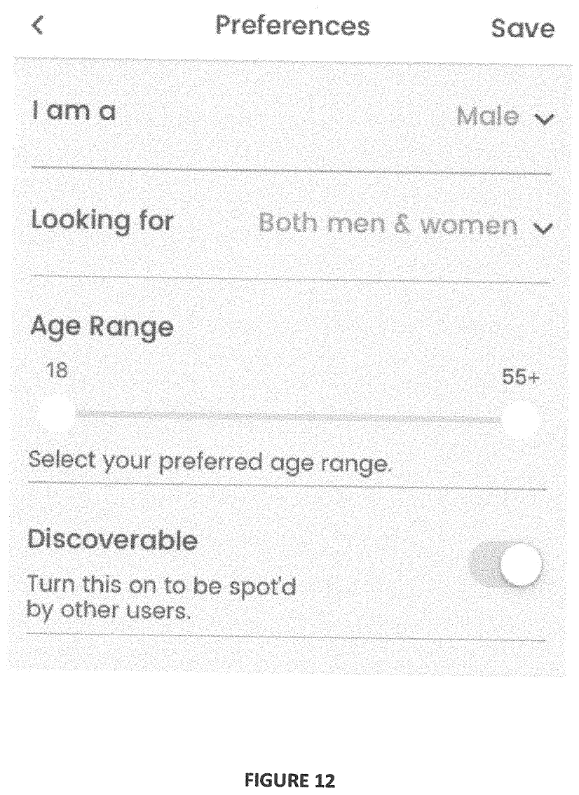

As shown by FIG. 12 the button therefore is a selective operation of the determination of finding second users and limits the operation in time, limits the operation within distance to relative the position at which the button is activated and limits the second users on the database that are relevant in that time and location.

Screen Shots

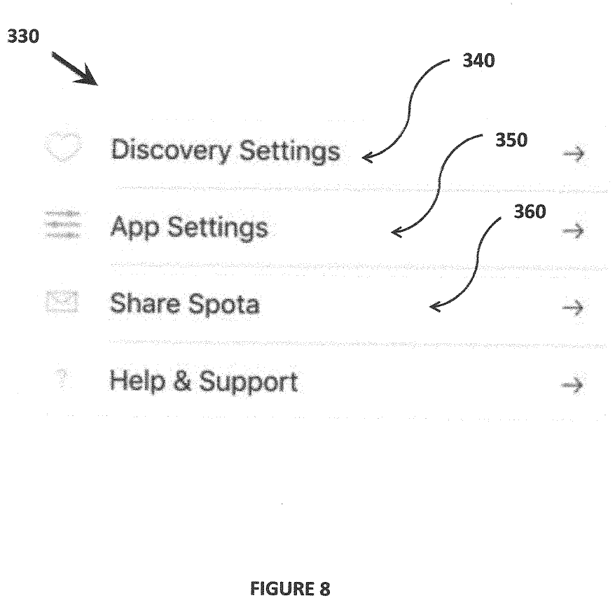

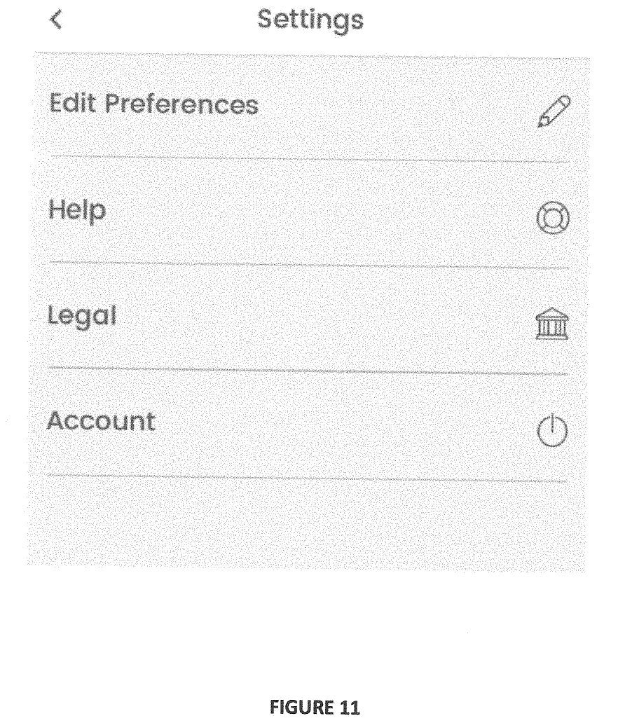

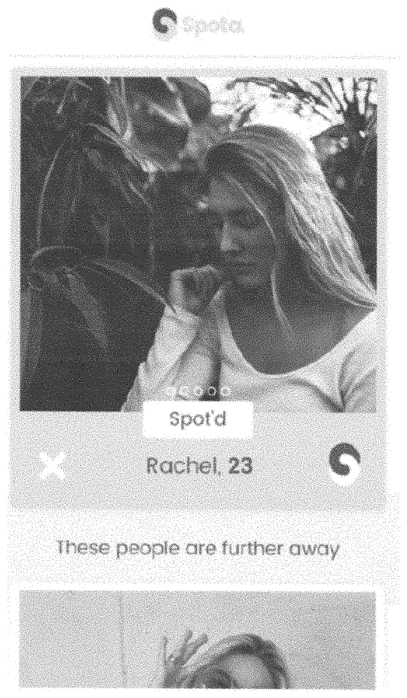

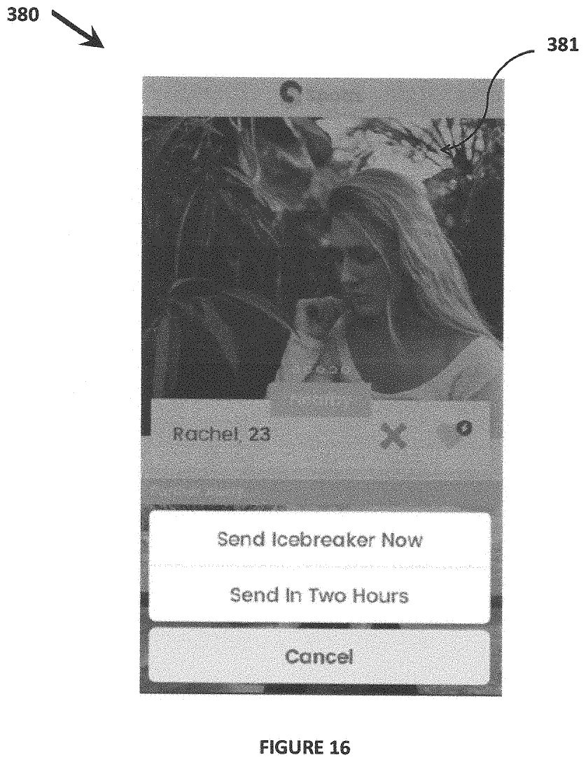

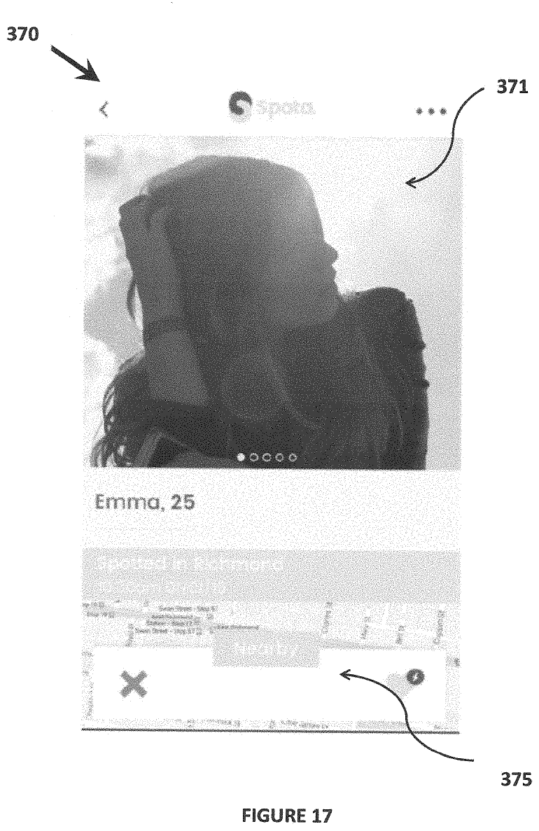

Referring to FIGS. 8 to 20, there are shown a plurality of screen shots on an app mon the first and second user's telecommunication device and connectable to a website or secondary computer running and maintaining the database. However instead of the system having all members live and searchable at all times it is restricted to those that have fulfilling of criteria, time and position so that they are available for further review.

FIG. 8 is a first screen page of an index page 330 of an app for use a system for social interaction by means of telecommunication system in accordance with a preferred embodiment of the present invention using fulfilling of all of the criteria of database, time and position. The index page has directions to discovery settings 340, app settings 350.

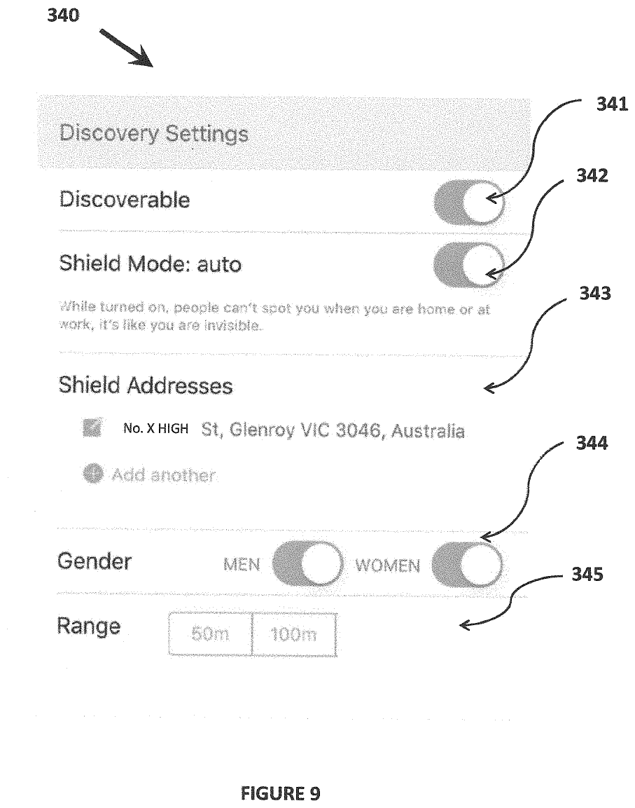

FIG. 9 is a second screen page showing criteria information of first user or second user. Including if the user wishes to be discoverable by selection 341 or to be in shield mode 342. Both can be activated where the shield mode activates at predefined locations such as home or work. This page also includes some inputs of criteria selection such as gender 344 and input of required distance of activation such as 345 which includes selection of 50 or 100 metres. Limitation of distances can be particularly relevant for limiting to a conference room or hotel lobby or a more general limited range area of radius 100 metres. However, this can be preset in the system or selected in identified geolocational language rather than metered diameters. Therefore, such are localized to provide improved spontaneous communication by the immediacy of location.

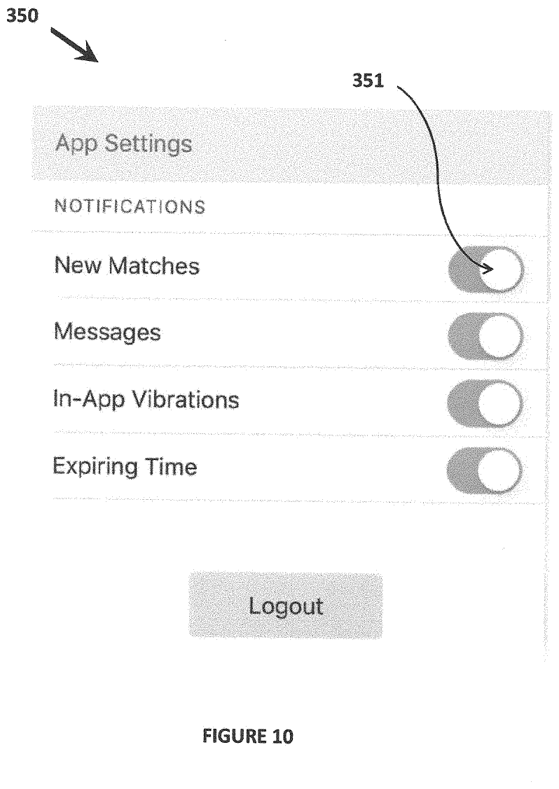

FIG. 10 is a third screen page which has option selections 351 including identifying new matches and activating the general system approaches.

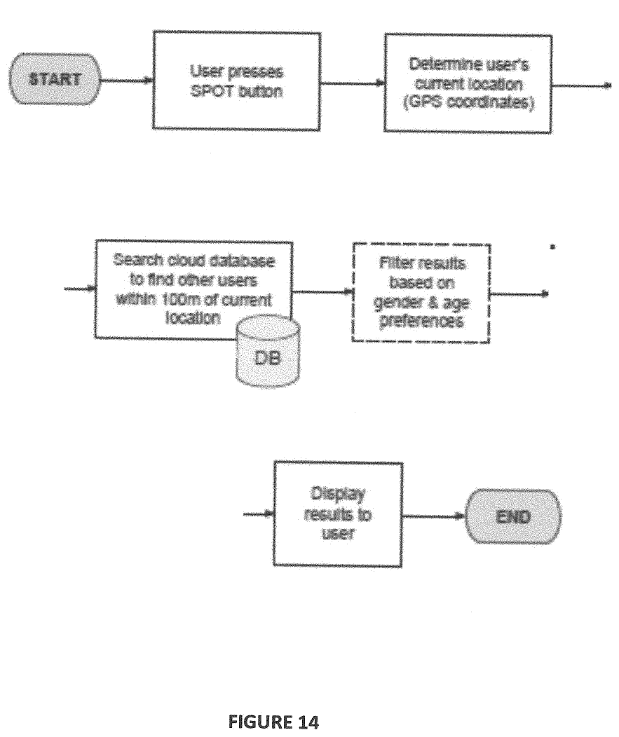

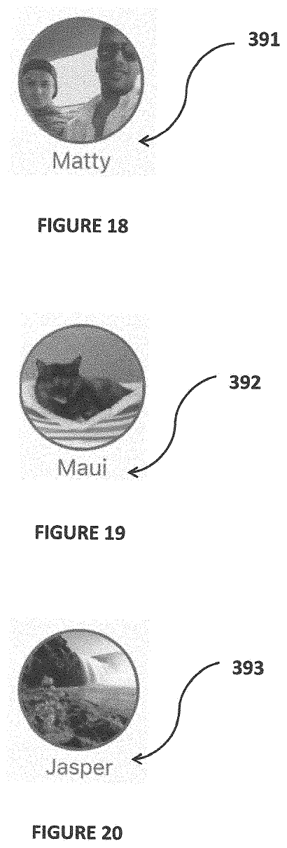

FIG. 13 is a screen page showing an activation button 361. Its operation is shown in FIG. 14. In this way, the short-term activation is operated to activate the system and to start the scanning. Scanning can be by searching for short span emitted electronic connections such as through Bluetooth or it can be by assessment of mobile telephone ID and matching to database or it can be by connection to remote database which sends your geographical position and activation code and transmits to others within the predefined location at the predefined short time to see if prospective second users respond. The system activates for immediacy of fulfilling the criteria of time, location and database and allow immediate indirect communication or delayed communication. This is shown particularly in FIGS. 18, 19 and 20 of actual possible second users dependent on predetermined criteria of geographical and time ranges.

FIGS. 15, 16 and 17 are further screen page showing possible connections between first user to prospective second users that has been activated at that location and at that time and showing geographical indication of actual possible second user. It is therefore enabling the first user to initiate the indirect notification 421 to the prospective second user 42 through an ice breaker question by selecting yes or to add and to later review.

Positional Determination

The determination of the location of possible second users is limited to 100 metres or less by use of a range of locational systems including:
a) GPS (global positioning satellites)
b) Telecommunication device triangulation of receiver/transmitter stations for mobile telecommunications;
c) API
d) Apple positioning system;
e) Significant position change determinations.

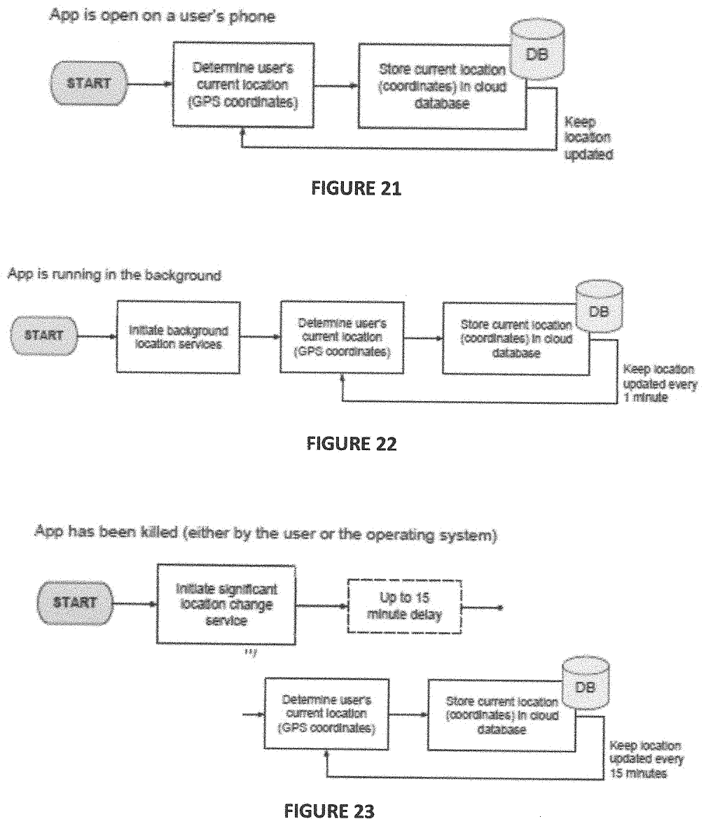

It is important, as shown in FIGS. 21, 22 and 23 that there is a continuation and recursive review of first user's location so that the system is ready upon activation of button to activate the

Time

Time is an important limitation as it provides a filter of immediacy. Generally, that immediacy is around a limited range around the present time. However, it can be that the limit is around a shifted time to a particular time. That particular time can be associated with a particular event and therefore gives you immediacy of operation around that event. It also could be around an activation time detailed by pressing of the button.

This gives an immediacy of the time around that activation time but allows for review to be undertaken at a separate time to the collection time.

The method for use in controlled immediacy social interaction wherein the enabling to use the telecommunication device of the first user to communicate with the telecommunication device of the one or more of the actual possible second users is by both the first user and the possible second users having assessed the possible connections and both agreeing to the connections.

The timer controller is able to immediately enable for a fixed predetermined limited time. These fixed predetermined limited time to immediately enable timer controller can be of the order 0 to 10 minutes or for more immediacy reduced to even of the order 0 to 2 minutes.

The timer controller further comprises the use of a button on the user's telecommunication device to activate the social media social interaction by use of the computer-implemented social networking service for a short time. The button can then activate the system to operate within the short time which is the fixed predetermined limited time to immediately enable timer controller of the order 0 to 10 minutes or even to the urgent immediacy of the fixed predetermined limited time to immediately enable timer controller of the order 0 to 2 minutes.

In one form the short time could be programmed to be operative only while the button is activated. This selective immediacy is then directly related to the first user's enabling choice in limited space and time and the systems analysis of fulfilling all of the criteria and instigating possibility of communication from first user to a selected one of possible second users identified by the system.

It can be seen that limited timing provides:
a) Immediacy of interaction;
b) Relevant limitation of possible second connections to allow immediacy of first user's choice of possible second user's;
c) Substantial limitation of required processing of data to enhance immediacy of processing.

Activation

An important aspect of the system is that a continuous operation results in substantial battery use. Therefore, it is important to have a control so that there is not a need for continuous operation in order for the user to have the social interaction using in combination a limited time range, a limited geographical range; and a limited criteria activation range. As shown in FIGS. 21 to 23 this is achieved by adapting operation.

As shown in FIG. 21 if the App is on the telecommunication device of the first user then the system can determine the user's current location by GPS or other geographical means and stores that location in the cloud database. A recursive action applies to keep the location updated. Clearly this is the most energy absorbing and battery depleting approach.

However, as shown in FIG. 20, if the app on the telecommunication device of the first user is instead running in the background there can be an initiate background location services. The system can determine the user's current location by GPS or other geographical means and stores that location in the cloud database. A recursive action applies to keep the location updated. However, this recursive undertaking is only sporadically or over separated times such as a minute apart.

The system can be running even more efficiently and even at battery usage of about 3% of the standard continual usage by undertaking a significant location change service. Therefore, sporadically there is a determination of the user's current location and GPS coordinates and storage to the cloud database. A brief review can determine whether there has been significant location change and therefore whether to initiate the accurate user's current location by GPS or other geographical means and stores that location in the cloud database and undertaking recursive action keep the location updated and more precisely pinpointed. The significant location change service allows for spacing of up to 15 minutes delay.

In this way, you can be maintaining localized time and geographically limited review of potential second users in an energy efficient manner.

Selective Operation by First and Second User

After the system determines which of the plurality possible second users 42 also fulfil all of the criteria of the membership database, the selected limited time of interaction and the selected limited geographical range being met there is still a selective operation.

The determination has resulted in there being identified actual possible second users. This list is small as it has been created only by fulfilling the location criteria, the time criteria and the database criteria.

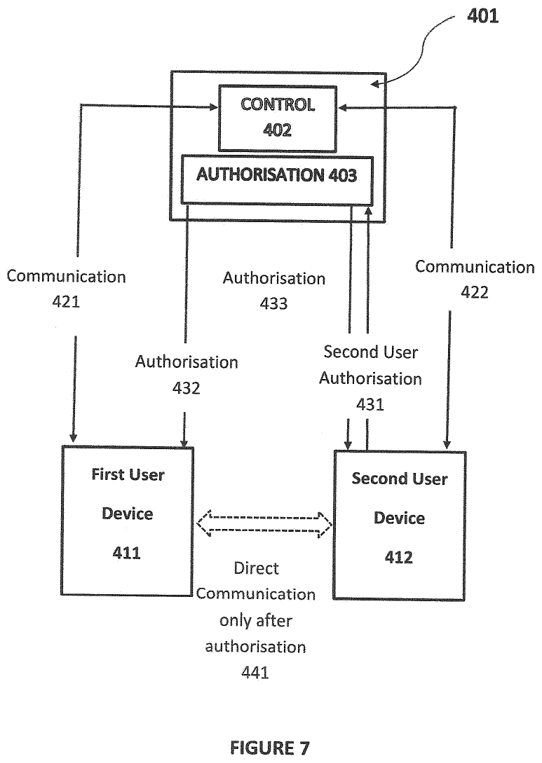

Referring to FIG. 7, to enact the computer-implemented social networking service by the first user being enabled to use their telecommunication device to initiate communication with one or more of the actual possible second users by the aid of the system and without knowledge of the communication address of the actual possible second users.

The communication between first user 41 and second user 42 is indirectly from the first user telecommunication device 411 of the first user 41 to the second user telecommunication device 412 of the second user 42 through the online system 401 that has a telecommunication control unit 402. This control unit is able to see the address of the second user 42 and enact contact with the second user 42 and pass on the communication from the first user without either the first or second user knowing the other's address. This is not allowed until authorised by the second user.

Apart from this disconnect of information there is also a control of communication so that there is not a personal, impolite, or bullying or other communication. The control of communication is by having a selection of ice breaker questions such that the first user 41 can select an ice breaker question from the control 402 and instruct with communication 421 to the control 402 to send the ice breaker question to the second user device 412 as communication 422. Therefore, communication before authorisation by the second user 42 is only by this ice breaker question.

The ice breaker questions are not user specific but are selected from a generated list so that there is not inappropriate communication prior to the second user agreeing to accept communication from the first user. Therefore, the ice breaker questions could be selected from:
a) What do you miss more Myspace or msn?
b) This is too easy . . . . To win 10 million dollars instantly or work hard for 5 years to earn 10 million dollars?
c) Tough one. To double dip or not to double dip?

It can be seen that there is an authorisation before there is direct communication.

Referring to FIG. 7, in order to ensure there is privacy before the second user agrees to accept communication from the first user the enabling to use the telecommunication device of the first user to communicate with the telecommunication device of the one or more of the actual possible second users is by retaining connection addresses of the first user and actual possible second users private from the first user and actual possible second users.

Therefore, the database has the contact and the first user has used the control 402 for searching of the criteria of the database without the first user 41 having readable access to the database. The computer system also enables the connection of the telecommunication of the first user to the telecommunication of the second user without releasing identification of the address information of the first and second user to either the first and second user. Only after selective acceptance of the

The enabling to use the telecommunication device of the first user to communicate with the telecommunication device of the one or more of the actual possible second users is by retaining connection addresses private of the first user and actual possible second users from the first user and actual possible second users. However, the telecommunication can automatically go through an intermediary connection or the central computing device so as to retain connection addresses private of the first user and actual possible second users from the first user and actual possible second users.

The activation of the instantaneous search at that activated time advises persons in predefined area or range of location and the activation of the activated time provides an ability for response by actual possible second users in the predefined area to receive notification.

Upon receiving the ice breaker question in communication 422, the nature of that question and some limited details of first user 41 can allow the second user 42 to send second user authorisation 431 from the second user telecommunication device 412 to the authorisation 403 of the online system 401. The authorisation unit 403 will therefore have details of communication and first and second users 41, 42 from the control 402 and can, if the second user authorisation 431 is favourable send authorisation 432, 433 to the first user device 411 and the second user device 412. These authorisations 432, 433 can enable the first user device 411 and the second user device 412 to communicate directly through direct communication channel 441.

There can be other variations to this system but by the combination of the plurality possible second users meeting fulfilling of all of the criteria of database, time and position and are therefore are actual possible second users and the short period time activation by activation button and localised geography and by both the first and second users wanting to connect and the allowance of an icebreaker chat across private lines without disclosure of contact details, there is a more immediate and spontaneous connection of people.

### Interpretation

### Embodiments

Reference throughout this specification to “one embodiment” or “an embodiment” means that a feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the electronic social interaction industries.

The claims defining the invention are as follows:

1. A system for computer-implemented social networking service by means of telecommunication comprising:
a. a central computing device; and
b. a computer-readable storage device connectable to the computing device and having instructions stored thereon
c. and the system further comprising:
i. a membership database connectable to the central computing device and adapted for a first user to ask for first user membership data to be limited to other users according to requested limiting criteria;
ii. a timer controller adapted for each user selectively limiting time of activation of the system relative to them; and
iii. a geographical determinator adapted for selectively limiting geographical range of activation of the system in which each user is located relative to another user;
d. a mobile telecommunication device, for each user and connectable to or integral with the central computing device and/or the computer-readable storage device, allowing selective communication between users;
e. wherein the system instructions executed by the computing device, cause the computing device to perform operations comprising:
i. determining a first user criteria requirements for a first user interaction with regard a possible second user, wherein a user criteria being met is based on the automatic review of the membership database for possible second users within the computer-implemented social networking service;
ii. determining that the criteria requirements of the first user and the operating criteria of the computer-implemented social networking service are met;
iii. identifying a plurality possible second users using the social networking service and their connection addresses;
wherein the system determines which of the plurality possible second users also fulfil all of the criteria of the membership database, the selected limited time of interaction and the selected limited geographical range being met and are therefore are actual possible second users to enact the computer-implemented social networking service by the first user being enabled to use their telecommunication device to initiate communication with one or more of the actual possible second users by the aid of the system and without knowledge of the communication address of the actual possible second users.

2. A system for social interaction by means of telecommunication system according to any one of the preceding claims wherein the timer controller further comprises the use of a button on the users telecommunication device to activate the social media social interaction by use of the computer-implemented social networking service for a short time.

3. A system for social interaction by means of telecommunication system according to any one of the preceding claims wherein the timer controller further comprises the use of a virtual button on the users telecommunication device screen to activate the social media social interaction by use of the computer-implemented social networking service for a short time.

4. A controlled immediacy social interaction system using telecommunication means according to any one of the preceding claims wherein the system provides the steps of:
(i) A first user seeing people of interest in immediate surrounds;
(ii) First user activating a communication means with plurality of criteria including: member of group, in predefined area, fulfilling criteria of user (e.g. looking for male or female of age of 18 to 25 or 25 to 30 years)
(iii) System sending offer of connection to actual possible second users being people fulfilling criteria and with their system being activated
(iv) A second user able to respond to system offer with system response
(v) A favourable system response able to be communicated to user
(vi) Enabling an instigation of not direct communication between user and favourable actual second users by means of telecommunication devices.

5. A system for social interaction by means of telecommunication system according to any one of the preceding claims wherein the enabling to use the telecommunication device of the first user to communicate with the telecommunication device of the one or more of the actual possible second users is by both the first user and the possible second users meeting fulfilling of all of the criteria of membership database, the selected limited time of interaction and the selected limited geographical range.

6. A system for social interaction by means of telecommunication system according to any one of the preceding claims wherein the enabling to use the telecommunication device of the first user to communicate with the telecommunication device of the one or more of the actual possible second users is by both the first user and the possible second users having activated the system in the selected limited time of interaction.

7. A system for social interaction by means of telecommunication system according to any one of the preceding claims wherein the enabling to use the telecommunication device of the first user to communicate with the telecommunication device of the one or more of the actual possible second users is by both the first user and the possible second users having assessed the possible connections by a selection of a randomly generation of ice breaking questions from the first user to the second user to enable both the first user and the second user to agree to the telecommunication connection.

8. A system for social interaction by means of telecommunication system according to any one of the preceding claims wherein the enabling to use the telecommunication device of the first user to communicate with the telecommunication device of the one or more of the actual possible second users is by retaining connection addresses of the first user and actual possible second users private from the first user and actual possible second users.

9. A system for social interaction by means of telecommunication system according to any one of the preceding claims wherein the enabling to use the telecommunication device of the first user to communicate with the telecommunication device of the one or more of the actual possible second users is automatically through an intermediary connection or the central computing device so as to retain connection addresses of the first user and actual possible second users private from the first user and actual possible second users.

10. A system for social interaction by means of telecommunication system according to any one of the preceding claims wherein the timer controller is able to immediately enable for a fixed predetermined limited time.

11. A system for social interaction by means of telecommunication system according to claim 10 wherein the fixed predetermined limited time to immediately enable timer controller is of the order 0 to 10 minutes.

12. A system for social interaction by means of telecommunication system according to claim 10 wherein the fixed predetermined limited time to immediately enable timer controller is of the order 0 to 2 minutes.

13. A system for social interaction by means of telecommunication system according to claim 11 or 12 wherein the timer controller further comprises a virtual button which is programmable onto the screen of the mobile telecommunication device and is therefore readily activated by the user touching the large touchscreen and activating the search and determination of which of the plurality possible second users also fulfil all of the criteria of the membership database, the selected limited time of interaction and the selected limited geographical range being met and are therefore are actual possible second users.

14. A system for social interaction by means of telecommunication system according to claim 13 wherein the short time is the fixed predetermined limited time to immediately enable timer controller of the order 0 to 10 minutes.

15. A system for social interaction by means of telecommunication system according to claim 13 wherein the short time is the fixed predetermined limited time to immediately enable timer controller of the order 0 to 2 minutes.

16. A system for social interaction by means of telecommunication system according to claim 13 wherein the short time is only while the button is activated.

17. A system for social interaction by means of telecommunication system according to any one of the preceding claims wherein the activation of the button is the only requirement for a user to selectively take their involvement of the system for computer-implemented social networking service by means of telecommunication from a standby mode to an active mode able to be substantially immediately assessed to be a first user or an actual possible second user.

18. A system for social interaction by means of telecommunication system according to any one of the preceding claims wherein the activation of the instantaneous search at that activated time advises persons in predefined area and the activation of the activated time provides an ability for response by actual possible second users in the predefined area to receive notification.

19. A system for social interaction by means of telecommunication system according to claim 18 wherein following the activation of the search, the communication between first user and second user is indirectly from the first user telecommunication device of the first user to the second user telecommunication device of the second user through the online system that has a telecommunication control unit wherein this control unit is able to see the address of the second user and enact contact with the second user and pass on the communication from the first user without either the first or second user knowing the others address.

20. A system for social interaction by means of telecommunication system according to claim 18 wherein following the communication between first user and second user is by having a selection of ice breaker questions such that the first user 41 can select an ice breaker question from the control and instruct with communication to the control to send the ice breaker question to the second user device as communication wherein the ice breaker questions are not user specific but are selected from a generated list so that there is not inappropriate communication prior to the second user agreeing to accept communication from the first user.

21. A system for social interaction by means of telecommunication system according to claim 20 wherein following receiving the ice breaker question a second user authorisation is able to be selectively sent from the second user telecommunication device to the authorisation of the online system and enable the first user device and the second user device to communicate directly through direct communication channel.

22. A controlled immediacy social interaction system using telecommunication means including the steps of:
(vii) A user seeing people of interest in immediate surrounds;
(viii) User activating a communication means with plurality of criteria including: member of group, in predefined area, fulfilling criteria of user (e.g. looking for male or female of age of 18 to 25 or 25 to 30 years)
(ix) System sending offer of connection to actual possible second users being people fulfilling criteria and with their system being activated
(x) A second user able to respond to system offer with system response
(xi) A favourable system response able to be communicated to user
(xii) Enabling an instigation of not direct communication between user and favourable actual second users by means of telecommunication devices.

23. A controlled immediacy social interaction system using telecommunication means according to claim 22 wherein the controlled immediacy social interaction uses in combination:
a. A limited time range;
b. A limited geographical range; and
c. A limited criteria activation range.

24. A controlled immediacy social interaction system using telecommunication means according to claim 23 wherein a timer controller provides limited time further comprises the use of a button on the users telecommunication device to activate the social media social interaction by use of the computer-implemented social networking service for a short time.

25. A controlled immediacy social interaction system using telecommunication means according to claim 23 wherein the timer controller further comprises the use of a virtual button on the users telecommunication device screen to activate the social media social interaction by use of the computer-implemented social networking service for a short time.

26. A controlled immediacy social interaction system using telecommunication means according to claim 22 wherein the enabling to use the telecommunication device of the first user to communicate with the telecommunication device of the one or more of the actual possible second users is by both the first user and the possible second users meeting fulfilling of all of the criteria of database, time and position.

27. A controlled immediacy social interaction system using telecommunication means according to claim 26 wherein the enabling to use the telecommunication device of the first user to communicate with the telecommunication device of the one or more of the actual possible second users is by both the first user and the possible second users having activated the system in the time.

28. A controlled immediacy social interaction system using telecommunication means according to any one of claims 22 to 27, wherein the enabling to use the telecommunication device of the first user to communicate with the telecommunication device of the one or more of the actual possible second users is by both the first user and the possible second users having assessed the possible connections and both agreeing to the connections.

29. A computer-implemented method using one or more processors on one or more telecommunication devices, the method comprising:
i. determining a first interactor user criteria requirements for a first user with regard a possible second user, wherein a user criteria being met is based on the automatic review of a database of possible second users within the computer-implemented social networking service;
ii. determining that the criteria requirements of the first user and the operating criteria of the computer-implemented social networking service are met;
iii. identifying a plurality possible second users using the social networking service and their connection addresses; and
in response to determining which of the plurality possible second users also meet fulfilling of all of the criteria of database, time and position being met and are therefore are actual possible second users to enact the computer-implemented social networking service by the first user being enabled to use their telecommunication device to communicate with one or more of the actual possible second users.

30. The method of claim 29 for use in controlled immediacy social interaction using in combination:
a. A limited time range;
b. A predefined or selectable limited geographical range; and
c. A limited criteria activation range.

31. A system for social interaction by means of telecommunication system according to any one of the preceding claims wherein the timer controller further comprises the use of a button on the users telecommunication device to activate the social media social interaction by use of the computer-implemented social networking service for a short time.

32. A system for social interaction by means of telecommunication system according to any one of the preceding claims wherein the timer controller further comprises the use of a virtual button on the users telecommunication device screen to activate the social media social interaction by use of the computer-implemented social networking service for a short time.

33. A method of controlled immediacy social interaction system including the steps of:
(i) A user seeing people of interest in immediate surrounds;
(ii) User activating a communication means with plurality of criteria including: member of group, in predefined area, fulfilling criteria of user (e.g. looking for male or female of age of 18 to 25 or 25 to 30 years)
(iii) System sending offer of connection to actual possible second users being people fulfilling criteria and with their system being activated
(iv) A second user able to respond to system offer with system response
(v) A favourable system response able to be communicated to user
(vi) Enabling an instigation of not direct communication between user and favourable actual second users by means of telecommunication devices.

34. The method of claim 33 for use in controlled immediacy social interaction wherein the controlled immediacy social interaction uses in combination:
a. A limited time range;
b. A limited geographical range; and
c. A limited criteria activation range.

35. The method of claim 34 for use in controlled immediacy social interaction wherein a timer controller provides limited time further comprises the use of a button on the users telecommunication device to activate the social media social interaction by use of the computer-implemented social networking service for a short time.

36. The method of claim 35 for use in controlled immediacy social interaction wherein the enabling to use the telecommunication device of the first user to communicate with the telecommunication device of the one or more of the actual possible second users is by both the first user and the possible second users meeting fulfilling of all of the criteria of database, time and position.

37. The method of claim 33 or 34 for use in controlled immediacy social interaction wherein the enabling to use the telecommunication device of the first user to communicate with the telecommunication device of the one or more of the actual possible second users is by both the first user and the possible second users having activated the system in the time.

38. The method of any one of claims 33 to 37 for use in controlled immediacy social interaction wherein the enabling to use the telecommunication device of the first user to communicate with the telecommunication device of the one or more of the actual possible second users is by both the first user and the possible second users having assessed the possible connections and both agreeing to the connections.

39. The method of any one of claims 35 to 38 wherein the timer controller is able to immediately enable for a fixed predetermined limited time.

40. The method of any one of claims 35 to 38 wherein the fixed predetermined limited time to immediately enable timer controller is of the order 0 to 10 minutes.

41. The method of any one of claims 35 to 38 wherein the fixed predetermined limited time to immediately enable timer controller is of the order 0 to 2 minutes.

42. The method of any one of claims 35 to 38 wherein the timer controller further comprises the use of a button on the users telecommunication device to activate the social media social interaction by use of the computer-implemented social networking service for a short time.

43. The method of claim 42 wherein the short time is the fixed predetermined limited time to immediately enable timer controller of the order 0 to 10 minutes.

44. The method of claim 42 wherein the short time is the fixed predetermined limited time to immediately enable timer controller of the order 0 to 2 minutes.

45. The method of claim 42 wherein the short time is only while the button is activated.

46. The method of any one of claims 33 to 45 wherein the activation of the button is the only requirement for a user to selectively take their involvement of the system for computer-implemented social networking service by means of telecommunication from a standby mode to an active mode able to be substantially immediately assessed to be a first user or an actual possible second user.

47. The method of any one of claims 33 to 45 including defining exclusion zones around the user by an electronic shield zone wherein a users phone is undiscoverable when shield activated or when a user is in a predefined position at which location they do not want to be found and is excluded.
